(19) United States
(12) Patent Application Publication
(10) Pub. No.: US 2005/0283651 A1
(43) Pub. Date: Dec. 22, 2005

(54) Disk controller, disk patrol method, and computer product

(75) Inventor: Nobuyuki Kikuchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/990,409

(22) Filed: Nov. 18, 2004

(30) Foreign Application Priority Data
Jun. 16, 2004 (JP) 2004-178444

(51) Int. Cl. G06F 11/00

(52) U.S. Cl. 714/6

(57) ABSTRACT

Read errors in a plurality of hard disks are detected at an early stage, and a redundancy is maintained when one of the hard disks breaks down. A hard-disk selector selects by priority a hard disk having a read error during a patrol. A verifying unit reads a predetermined amount of data from the hard disk selected. An error detector determines whether the read error has occurred. When it is determined that the read error has occurred, a replacing unit secures a spare area, and stores the corresponding data in the spare area.

### BACKGROUND OF THE INVENTION

1) Field of the Invention

The present invention relates to a disk controller that sequentially reads data from a plurality of disk drives and performs patrol to confirm a normal operation of the disk drives, and more particularly, to a disk controller that can detect an error occurring in the disk drive at an early stage, a disk patrol method, and a disk patrol program.

2) Description of the Related Art

Conventionally, a disk array apparatus handles a plurality of hard disks as a single logical volume. The hard disks of the disk array apparatus have redundant constitutions so that, if one of the disk drives breaks down, data of the broken disk can be restored from data stored on other hard disks.

However, when one of the hard disks breaks down and the other hard disks are used in restoring the data of the broken disk, the data cannot be reconstituted if an error occurs while reading the other hard disks.

Accordingly, in addition to accessing from the host computer, the disk array apparatus accesses the hard disks using a method of “patrol”, sequentially reads data from the hard disks in cycles, and when a read error occurs, secures a spare area to replace the data area where the read error occurred, and writes the corresponding data in the spare area to ensure a redundancy.

For example, Japanese Patent Application Laid-open Publication No. H10-260789 discloses a technique for restoring the redundancy by incorporating a breakdown replacing device from other logical group having a high redundancy when one of the hard disks is broken down.

However, in the conventional technique, the error in the hard disk cannot be detected at an early stage, making it impossible to ensure the redundancy when a hard disk is broken down.

Specifically, the conventional technique ignores the fact that a hard disk in which a read error has occurred once is likely to suffer another read error in multiple locations, and patrols the hard disks without assigning a priority over normal disks to disks where the error has occurred. This makes it impossible to detect multiple errors at an early stage, which are likely to exist in a hard disk where a read error has already occurred once.

The redundancy cannot be ensured when one of the hard disks breaks down before they have been sufficiently patrolled, and therefore, when the error occurs in the other hard disks, the data of the broken disk cannot be reliably restored.

In addition, to avoid competition with a data-access from the host computer, patrol cannot be performed continuously, making the early detection of the read error even more difficult.

### SUMMARY OF THE INVENTION

It is an object of the present invention to solve at least the above problems in the conventional technology.

A disk controller according to one aspect of the present invention, which sequentially reads data from a plurality of disk drives, and performs a patrol to confirm a normal operation of the disk drives, includes a selecting unit that selects by priority a disk drive having a read error during the patrol; and a determining unit that reads the data from the disk drive selected by the selecting unit, and determines whether the read error has occurred on the disk drive.

A disk patrol method according to another aspect of the present invention, which is for a disk controller that sequentially reads data from a plurality of disk drives, and performs a patrol to confirm a normal operation of the disk drives, includes selecting by priority a disk drive having a read error during the patrol; reading the data from the disk drive selected by the selecting unit; and determining whether the read error has occurred on the disk drive.

A computer-readable recording medium according to still another aspect of the present invention stores a disk patrol program that causes a computer to execute the above disk patrol method according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic for illustrating a concept of a disk patrol according to the present invention;

FIG. 2 is another schematic for illustrating the concept of the disk patrol according to the present invention;

FIG. 3 is still another schematic for illustrating the concept of the disk patrol according to the present invention;

FIG. 4 is a schematic for illustrating a data configuration of a hard disk;

FIG. 5 is a block diagram of a disk array controller shown in FIGS. 1 to 3;

FIG. 6 is a schematic of an error-occurrence management table, a selection information area, and an error-disk-selection information area held by a hard-disk selector;

FIG. 7 is a flowchart of a process procedure for a disk patrol process;

FIG. 8 is a flowchart of a process procedure for a hard-disk selection process;

FIG. 9 is a flowchart of a process procedure for a replacement process; and

FIG. 10 is a flowchart of a process procedure for an intensively disk patrol for an error disk.

### DETAILED DESCRIPTION

Exemplary embodiments of a disk controller, a disk patrol method, and a computer product according to the present invention will be explained in detail with reference to the accompanying drawings.

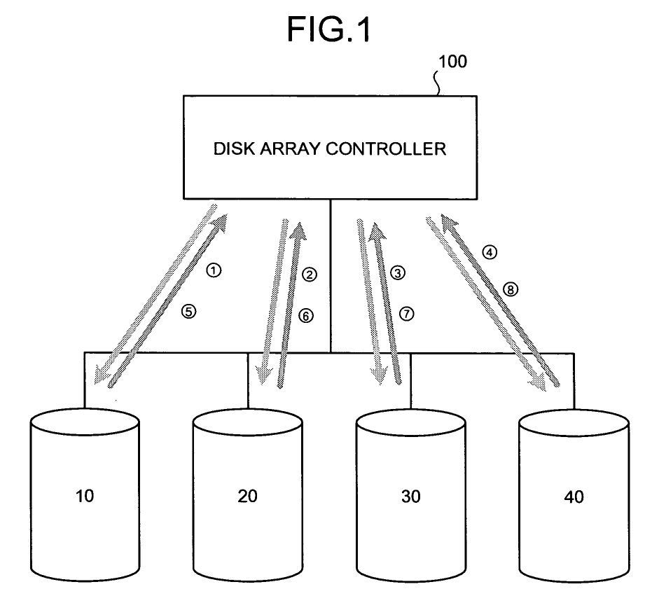

FIGS. 1 to 3 are schematics for illustrating a concept of a disk patrol according to an embodiment of the present invention. The disk patrol includes sequentially reading data from hard disks in cycles, and, when a read error occurs, securing an area (hereinafter, “a spare area”) to replace the data area where the read error occurred, and writing the corresponding data in the spare area.

As shown in FIGS. 1 to 3, a disk array controller 100 connects to hard disks 10 to 40. For sake of convenience, there are shown only four hard disks 10 to 40 in this example, but the disk array controller 100 may be connected to any number of hard disks. The disk array controller 100 shown in FIGS. 1 to 3 includes a redundant array of inexpensive disks (RAID) using the hard disks 10 to 40.

As shown in FIG. 1, when no read errors are occurring in any of the hard disks 10 to 40, the disk array controller 100 patrols them sequentially in the order of 10, 20, 30, 40, and 10.

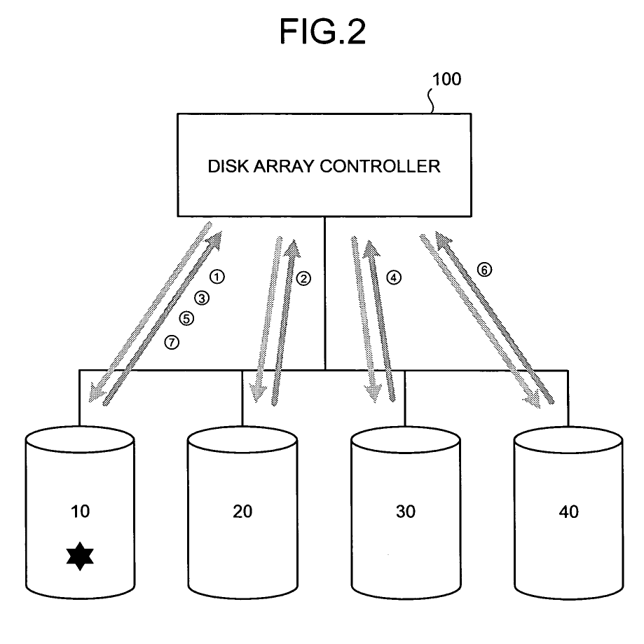

As shown in FIG. 2, when a read error occurs in the hard disk 10 while the hard disks 20 to 40 function normally, the disk patrol is performed with emphasis on the hard disk 10. Specifically, when a read error occurs in the hard disk 10, the disk array controller 100 patrols the hard disks in the order of 10, 20, 10, 30, 10, 40, and 10.

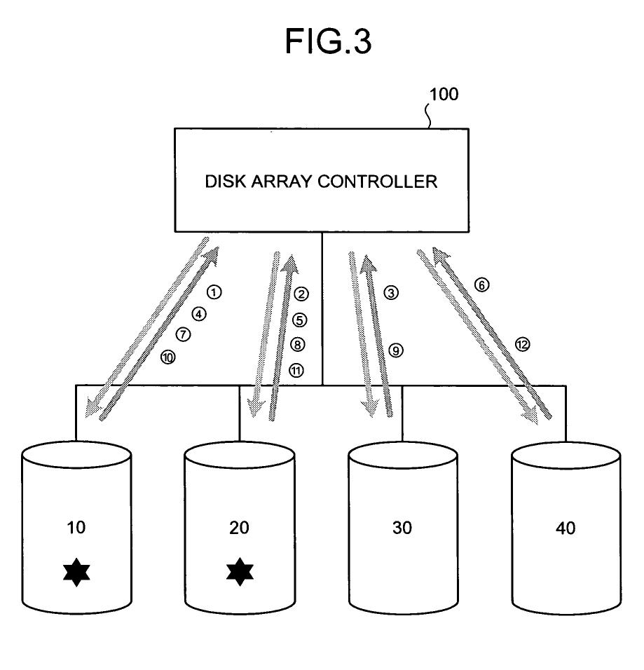

As shown in FIG. 3, when read errors occur in the hard disks 10 and 20 while the hard disks 30 and 40 remain normal, the disk patrol is performed with emphasis on the hard disks 10 and 20. Specifically, when read errors occur in the hard disks 10 and 20, the disk array controller 100 patrols the hard disks in the order of 10, 20, 30, 10, 20, 40, 10, 20, and 30.

That is, the disk array controller 100 divides the hard disks into a group of those where read errors have occurred (hereinafter, “error disks”), and a group of those where read errors have not occurred (hereinafter, “normal hard disks”).

The hard disks in each group are patrolled while alternately selecting the group of error disks and the group of normal hard disks. When the error disk group is selected, all the disks in the error disk group are patrolled, and then a hard disk in the normal disk group are selected and patrolled. After selecting and patrolling one normal hard disk in the normal disk group, a hard disk in the error disk group is selected and patrolled.

By patrolling the hard disks with emphasis on the error disks, the disk array controller 100 can detect other errors on the hard disks at an early stage, enabling redundancy to be restored. This is due to the fact that errors are likely to occur in a hard disk where a read error has occurred, and such disks are patrolled more frequently.

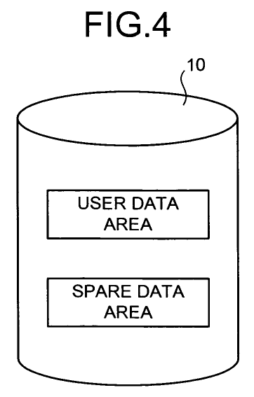

FIG. 4 is a schematic for illustrating a data configuration of the hard disk 10. The hard disks 20 to 40 have the same data constitution as the hard disk 10.

As shown in FIG. 4, the data management server apparatus 10 has a user data area, and a spare data area. The user data area stores general data, and the spare data area is used instead of a user data area, in which a read error has occurred during the disk patrol, to store the corresponding data

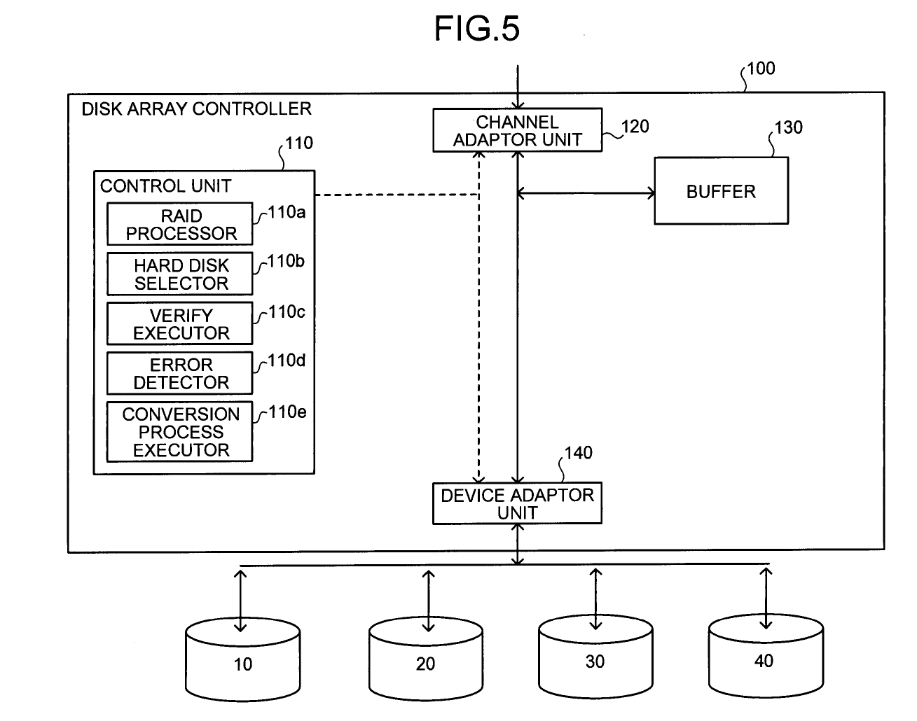

FIG. 5 is a block diagram of a disk array controller 100 shown in FIGS. 1 to 3. As shown in FIG. 5, the disk array controller 100 includes a control unit 110, a channel adaptor unit 120, a buffer 130, and a device adaptor unit 140.

The control unit 110 is a processor that controls the entire disk array controller 100, and includes a RAID processor 110a, a hard-disk selector 110b, a verify executor 110c, an error detector 110d, and a replacement process executor 110e.

When the channel adaptor unit 120 has received data from a host computer (not shown), the RAID processor 110a stores the received data temporarily in the buffer 130. The RAID processor 110a then disperses and writes the data, which is stored in the buffer 130, to the hard disks 10 to 40 via the device adaptor unit 140.

For example, when the channel adaptor unit 120 has sequentially received data of A, B, C, D, E, and F, from the host computer, the RAID processor 110a writes A, C, and E to the hard disk 10, writes B, D, and F to the hard disk 20, writes A, C, and E to the hard disk 30, and writes B, D, and F to the hard disk 40, via the device adaptor unit 130.

The RAID processor 110a responds to a data request from the host computer by searching the requested data from the hard disks 10 to 40. The RAID processor 110a momentarily stores the searched data in the buffer 130, and then passes it to the host computer.

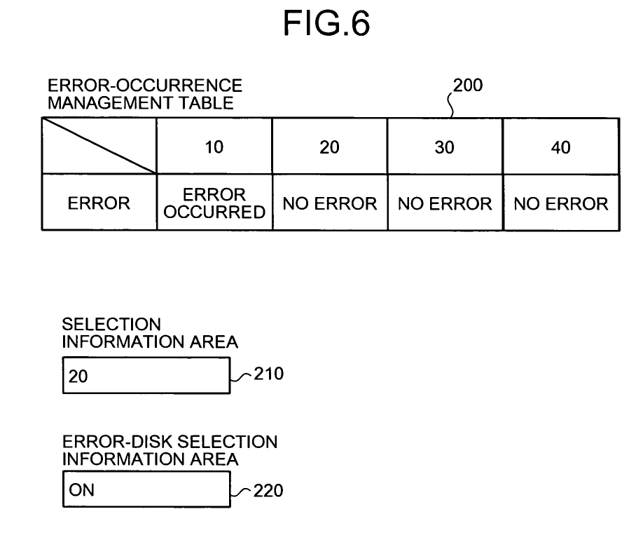

The hard-disk selector 110b is a processor that selects one by one a plurality of hard disks that are being patrolled. When selecting, the hard-disk selector 110b gives priority to error disks over normal hard disks. The hard-disk selector 110b stores an error-occurrence management table 200, a selection information area 210, and an error hard disk selection information area 220, shown in FIG. 6.

The hard-disk selector 110b selects hard disks for the disk patrol by using information stored in the error-occurrence management table 200 and the selection information area 210, and information stored in the error hard disk selection information area 220.

The error-occurrence management table 200 is a table for managing information relating to which hard disks read errors have occurred in. For example, the error-occurrence management table 200 of FIG. 6 shows that a read error has occurred in the hard disk 10, while the hard disks 20 to 40 are normal. In this case, the hard-disk selector 110b selects hard disks to be patrolled in the order of 10, 20, 10, 30, 10, and 40. The content of the error-occurrence management table 200 is updated by the error detector 110d, described later.

When the hard-disk selector 110b has received from the verify executor 110c (described later) information stating that a second read error did not occur after reading all of the data in the error disk, the hard-disk selector 110b changes the error information of the corresponding hard disk in the error-occurrence management table 200 from “error occurred” to “no error”. In this case, the hard disk is treated as a normal hard disk until the next error occurs (i.e. a hard disk belonging to the error disk group is returned to the normal disk group, thereby returning the patrol priority level of the disk to its original level).

The selection information area 210 stores identification information for identifying the last hard disk that is selected from among the normal hard disks by the hard-disk selector 110b. For example, the selection information area 210 shown in FIG. 6 has identification information of 20, indicating that the hard disk 20 is the last disk to be selected from the normal hard disks by the hard-disk selector 110b.

The error hard disk selection information area 220 stores information indicating whether the last hard disk that is selected by the hard-disk selector 110b is an error disk or a normal hard disk.

Specifically, when the information stored in the error hard disk selection information area 220 is “ON”, this indicates that the last hard disk selected is an error disk, and information of “OFF” indicates that the last hard disk selected is a normal hard disk.

The verify executor 110c reads a predetermined amount of data from the hard disk, selected by the hard-disk selector 110b, and passes the read data to the error detector 110d. When reading the predetermined amount of data from the selected hard disk, the verify executor 110c stores the position of the data area where the data being read out is stored.

When the hard-disk selector 110b has selected the same hard disk a second time, the verify executor 110c reads a predetermined amount of data from the next data area after the stored data area, and passes the read out data to the error detector 110d.

When the verify executor 110c has received information indicating that an error has occurred from the error detector 110d, the verify executor 110c stores the data area of hard disk where the error occurred. When all of the data has been read out from the error disk without a second read error occurring, the verify executor 110c notifies the hard-disk selector 110b of this fact.

The error detector 110d is a processor that extracts the data, which is read by the verify executor 110c, and determines whether a read error has occurred. When the verify executor 110c determines that a read error has occurred, it passes information indicating that the read error has occurred to the hard-disk selector 110b, the verify executor 110c, and the replacement process executor 110e.

In addition, the error detector 110d counts the number of errors occurring in each hard disk, and isolates any hard disk in which the number of errors exceeds a predetermined number.

When the replacement process executor 110e has received the information indicating that an error has occurred from the error detector 110d, it allocates a spare area to replace the area where the read error has occurred, restores the data of the area where the read error occurred based on data obtained from another hard disk, and writes the data in the spare area.

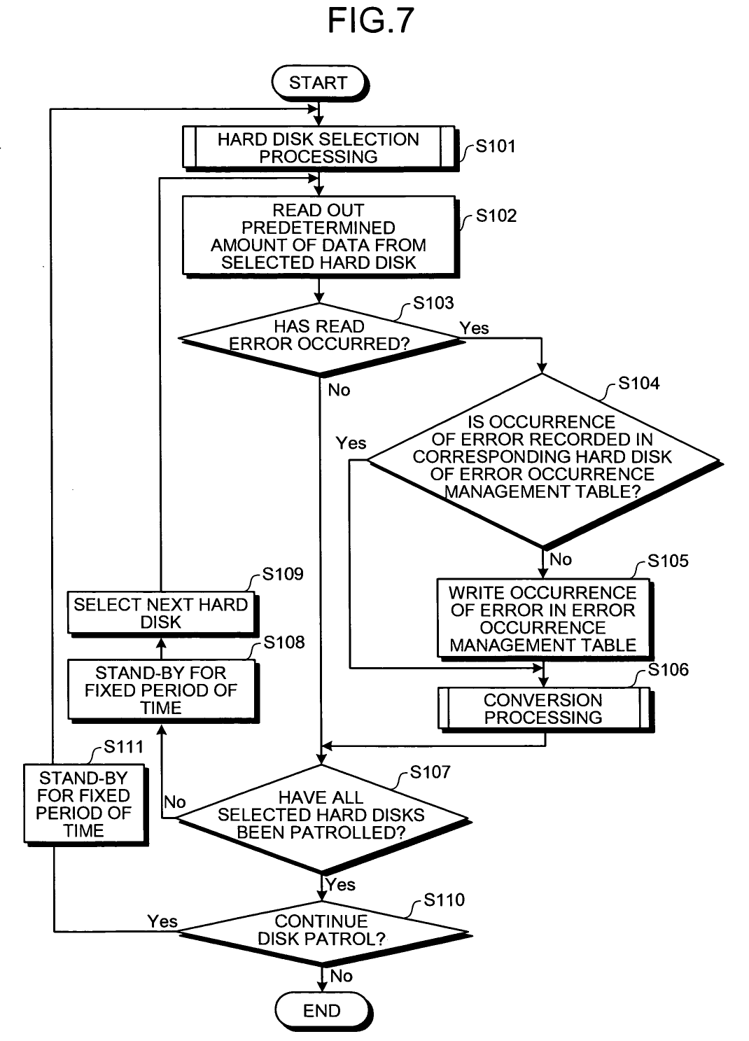

FIG. 7 is a flowchart of a process procedure for a disk patrol process. As shown in FIG. 7, the hard-disk selector 110b performs a hard disk selection process (step S101), the verify executor 110c reads a predetermined amount of data from the selected hard disk (step S102), and the error detector 110d confirms whether a read error has occurred (step S103).

When a read error has occurred (step S103, Yes), the hard-disk selector 110b determines whether the occurrence of the error is written in the corresponding hard disk of the error-occurrence management table 200 (step S104), and if not (step S104, No), writes the occurrence of the error in the error-occurrence management table 200 (step S105), and the replacement process executor 110e performs a replacement process (step S106).

When the occurrence of the error is recorded in the corresponding hard disk of the error-occurrence management table 200 (step S104, Yes), processing proceeds directly to step S206.

On the other hand, when no read error has occurred (step S103, No), the hard-disk selector 110b determines whether all the selected hard disks have been patrolled (step S107), and if they have not (step S107, No), stands by for a fixed period of time (step S108), selects the next hard disk (step S109), and shifts to step S102.

When all the selected hard disks have been patrolled (step S107, Yes), it is determined whether to continue a disk patrol (step S110). When it has determined to continue the disk patrol (step S110, Yes), the hard-disk selector 110b stands by for a fixed period of time (step S111) before shifting to step S101. When it is determined not to continue the disk patrol (step S110, No), processing ends.

A supplementary explanation of the disk patrol processing shown in FIG. 7 will be described, using FIGS. 2 and 3. When the hard disk 10 is the only hard disk in which a read error has occurred as in FIG. 2, in the hard disk selection process of step S101, the hard-disk selector 110b selects the hard disks in the sequence of 10, 20, 10, 30, 10, and 40.

As shown in FIG. 3, when read errors have occurred in hard disks 10 and 20, in the hard disk selection process of step S101, the hard-disk selector 110b simultaneously selects the hard disks 10 and 20. In step S102, a predetermined amount of data is read out from the hard disk 10, and an error check is carried out.

In step S109, the remaining hard disk 20 is selected and error-checked, and the processing shifts to step S110. Namely, when read errors have occurred in the hard disks 10 and 20, the hard-disk selector 110b selects the hard disks in the sequence of 10, 20, 30, 10, 20, 40, 10, 20, 30, 10, 20, and 40.

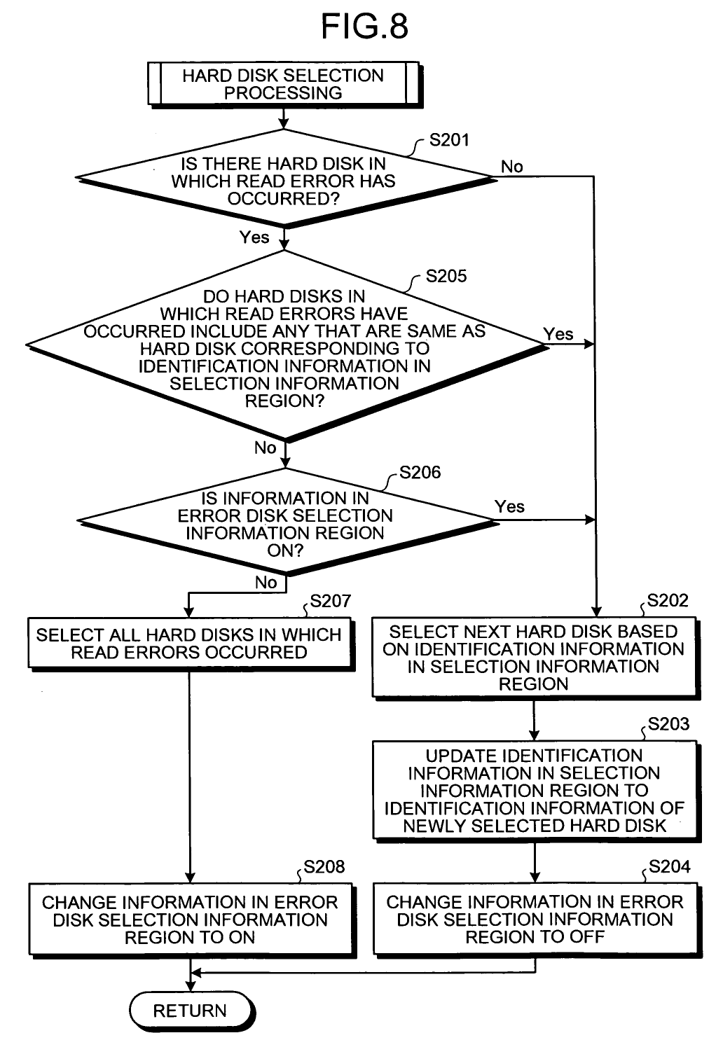

FIG. 8 is a flowchart of a process procedure for a hard-disk selection process. As shown in FIG. 8, the hard-disk selector 110b determines whether there is a disk in which a read error has occurred (step S201).

When there is no hard disk in which a read error has occurred (step S201, No), the hard-disk selector 110b selects the next hard disk based on the identification information recorded in the selection information area 210 (step S202), updates the identification information recorded in the selection information area 210 to that of the newly selected hard disk (step S203), and changes the information of the error hard disk selection information area 220 to OFF (step S204).

When there is a hard disk in which a read error has occurred (step S202, Yes), it is determined whether the hard disks in which the read errors have occurred include any that are the same as the hard disk corresponding to the identification information of the selection information area 210 (step S205).

When the hard disks in which the read errors have occurred include the hard disk that corresponds to the identification information (step S205, Yes), processing shifts to step S202.

On the other hand, when none of the hard disks in which the read errors have occurred are the same as the hard disk that corresponds to the identification information (step S205, No), it is determined whether the information in the error hard disk selection information area 220 is ON (step S206).

When the information in the error hard disk selection information area 220 is ON (step S206, Yes), processing shifts to step S202.

When the information in the error hard disk selection information area 220 is OFF (step S206, No), the hard-disk selector 110b selects all the hard disks in which errors have occurred (step S107), and changes the information in the error hard disk selection information area 220 to ON (step S108).

In step S201 of FIG. 8, the hard-disk selector 110b determines whether an error has occurred based on the error-occurrence management table 200.

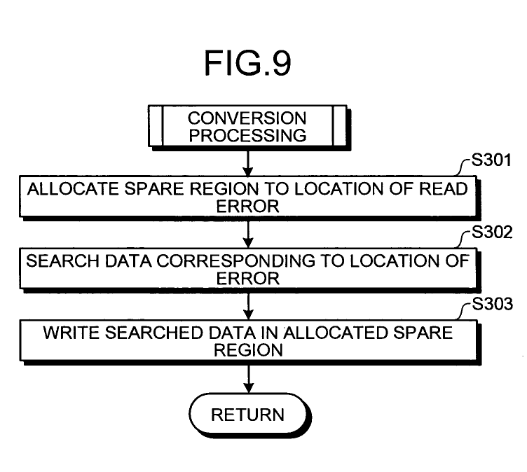

FIG. 9 is a flowchart of a process procedure for a replacement process. As shown in FIG. 9, the replacement process executor 110e allocates a spare area that corresponds to the location of the read error (step S301), searches the data that corresponds to the location of the error (step S302), and writes the searched data in the allocated spare area (step S302).

As described above, in the disk array controller 100 according to this embodiment, the hard-disk selector 110b selects by priority hard disks in which read errors have occurred, the verify executor 110c reads a predetermined amount of data from the selected hard disks, the error detector 110d determines whether a read error has occurred, and if so, the replacement process executor 110e secures a spare area and stores the data in it.

This enables the disk patrol to be performed with emphasis on the error disks, in which there is a higher possibility of multiple read errors than in normal disks, and enables error areas to be detected at an early stage, so that redundancy can be maintained when a hard disk breaks down.

The sequence of selecting hard disks for patrol is not restricted to the one described in the embodiment. For example, when a read error has occurred in a hard disk, the error disk may be patrolled intensively and the normal disks are patrolled later.

In other words, when a read error has occurred in the hard disk 10, all the data included in the hard disk 10 is patrolled first, and the normal disks are patrolled after the patrol of the hard disk 10 has ended.

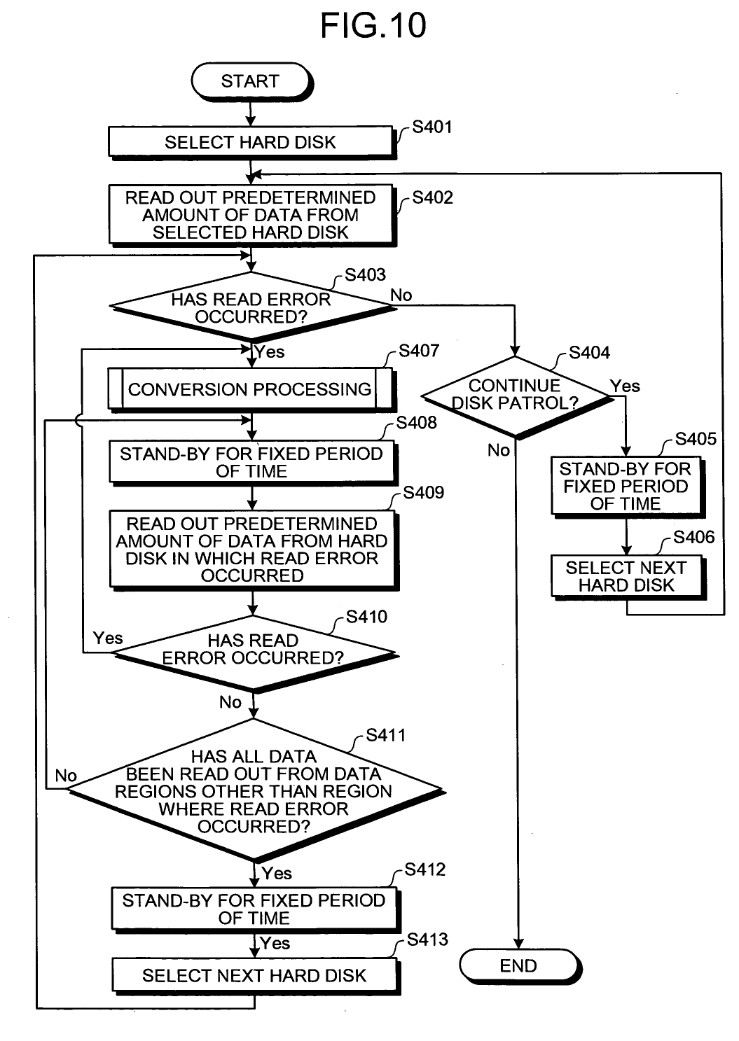

FIG. 10 is a flowchart of the processing sequence for intensively performing disk patrol on an error disk. As shown in FIG. 10, the hard-disk selector 110b selects a hard disk (step S401), the verify executor 110c reads a predetermined amount of data from the selected hard disk (step S402), and the error detector 110d determines whether a read error has occurred (step S403).

When no read error has occurred (step S403, No), it is determined whether to continue a disk patrol (step S404). When continuing the disk patrol (step S404, Yes), the hard-disk selector 110b stands by for a fixed period of time (step S405), selects the next hard disk (step S406), and shifts to step S402. When the disk patrol is not to be continued (step S404, No), the processing ends.

When a read error has occurred (step S403, Yes), a replacement process is executed (step S407), and, after standing by for a fixed time (step S408), a predetermined amount of data is read out from the hard disk in which the error occurred (step S409), and the error detector 110d determines whether an error has occurred (step S410).

When a read error has occurred (step S410, Yes), processing shifts to step S408. When no read error has occurred (step S410, No), it is determined whether all data has been read out from data areas other than the one where the read error occurred (step S411).

When all the data has not been read (step S4114, No), processing shifts to step S408. On the other hand, when all the data has been read (step S411, Yes), the hard-disk selector 110b stands by for a fixed time (step S412), selects the next hard disk (step S413), and shifts to step S403.

By patrolling the error disks, in which multiple read errors are likely to occur, intensively in this way, the error locations can be efficiently detected, and redundancy when a hard disk breaks down can be restored at an early stage.

The replacement process shown in step S407 of FIG. 10 is the same as that shown in FIG. 9, and the explanation thereof will be omitted.

According to the present invention, a disk drive, in which a read error has occurred during patrol, is selected by priority from among a plurality of disk drives, data is read out from the selected disk drive, and it is determined whether a read error has occurred. Therefore, error locations in the disk drives can be detected at an early stage, and redundancy when a disk drive breaks down can be maintained also at an early stage.

Furthermore, according to the present invention, the disk drives are divided into an error disk group, including disk drives in which read errors occurred during patrol, and a normal disk group, including normal disk drives, and it is determined whether a read error has occurred in disk drives in the error disk group. Therefore, error locations in the disk drives can be efficiently detected, and redundancy when a disk drive breaks down can be restored at an early stage.

Moreover, according to the present invention, after it is determined whether read errors have occurred in all data areas of the disk drive in which the read error occurred during patrol, a next disk drive is selected, and it is determined whether a read error has occurred therein. Therefore, patrol of disk drives in which read errors are likely to occur can be completed early, enabling redundancy when a disk drive breaks down to be maintained at an early stage.

Although the invention has been described with respect to a specific embodiment for a complete and clear disclosure, the appended, claims are not to be thus limited but are to be construed as embodying all modifications and alternative constructions that may occur to one skilled in the art which fairly fall within the basic teaching herein set forth.

1. A disk controller that sequentially reads data from a plurality of disk drives, and performs a patrol to confirm a normal operation of the disk drives, the disk controller comprising:
a selecting unit that selects by priority a disk drive having a read error during the patrol; and
a determining unit that reads the data from the disk drive selected by the selecting unit, and determines whether the read error has occurred on the disk drive.

2. The disk controller according to claim 1, further comprising a storage unit that stores identification information for identifying the disk drive having the read error the during patrol, wherein
the selecting unit selects by priority the disk drive having the read error based on the identification information stored in the storage unit.

3. The disk controller according to claim 1, wherein
the selecting unit divides the disk drives into an error disk group that includes the disk drive having the read error during the patrol and a normal disk group that includes a normal disk drive, and
after selecting all the disk drives in the error disk group, the selecting unit switches to the normal disk group, selects one disk drive from the normal disk group, and then switches to the error disk group.

4. The disk controller according to claim 1, wherein the selecting unit selects a next disk drive after it is determined whether the read error has occurred in all data areas of the disk drive having the read error during the patrol.

5. A disk patrol method for a disk controller that sequentially reads data from a plurality of disk drives, and performs a patrol to confirm a normal operation of the disk drives, the disk patrol method comprising:
selecting by priority a disk drive having a read error during the patrol;
reading the data from the disk drive selected by the selecting unit; and
determining whether the read error has occurred on the disk drive.

6. The disk patrol method according to claim 5, further comprising storing identification information for identifying the disk drive having the read error the during patrol, wherein
the selecting includes selecting by priority the disk drive having the read error based on the identification information stored.

7. The disk patrol method according to claim 5, wherein the selecting includes
dividing the disk drives into an error disk group that includes the disk drive having the read error during the patrol and a normal disk group that includes a normal disk drive;
switching, after selecting all the disk drives in the error disk group, to the normal disk group;
selecting one disk drive from the normal disk group; and
switching to the error disk group.

8. The disk patrol method according to claim 5, wherein the selecting includes selecting a next disk drive after it is determined whether the read error has occurred in all data areas of the disk drive having the read error during the patrol.

9. A computer-readable recording medium that stores a disk patrol program for a disk controller that sequentially reads data from a plurality of disk drives, and performs a patrol to confirm a normal operation of the disk drives, the disk patrol program making a computer execute:
selecting by priority a disk drive having a read error during the patrol;
reading the data from the disk drive selected by the selecting unit; and
determining whether the read error has occurred on the disk drive.

10. The computer-readable recording medium according to claim 9, wherein
the disk patrol program further makes the computer execute storing identification information for identifying the disk drive having the read error the during patrol, wherein
the selecting includes selecting by priority the disk drive having the read error based on the identification information stored.

11. The computer-readable recording medium according to claim 9, wherein the selecting includes
dividing the disk drives into an error disk group that includes the disk drive having the read error during the patrol and a normal disk group that includes a normal disk drive;
switching, after selecting all the disk drives in the error disk group, to the normal disk group;
selecting one disk drive from the normal disk group; and
switching to the error disk group.

12. The computer-readable recording medium according to claim 9, wherein the selecting includes selecting a next disk drive after it is determined whether the read error has occurred in all data areas of the disk drive having the read error during the patrol.
